(19) United States
(12) Patent Application Publication
(10) Pub. No.: US 2012/0094264 A1
(43) Pub. Date: Apr. 19, 2012

(54) Method for Loss Prevention with a Specialty in MIDI by Means of an Online Learning and Training Academy

(76) Inventor: Taydama Saykon JACKSON, Douglasville, GA (US)

(21) Appl. No.: 13/280,147

(22) Filed: Oct. 24, 2011

Related U.S. Application Data
(63) Continuation-in-part of application No. 12/903,670, filed on Oct. 13, 2010.

(51) Int. Cl. G09B 7/00

(52) U.S. Cl. 434/322

(57) ABSTRACT

The present invention educates about loss prevention through a learning and teaching program that certifies trainees in teaching English, MIDI, and loss prevention. Through learning English and MIDI, a trainee can help a safer community by increasing driver safety awareness and reducing crime by gaining knowledge about civil rights. The present invention also allows trainees to learn through one-on-one apprenticeships with working professionals and therefore obtain job training much earlier than traditional schooling. Also, the academy helps trainees learn self-control and self-expression through their various learning and educating techniques.

The current application is a continuation in part that claims a priority to the U.S. non-provisional patent application Ser. No. 12/903,670 filed on Oct. 13, 2010.

### FIELD OF THE INVENTION

The present invention relates generally to an online learning and training academy for the prevention of loss with a specialty in MIDI. Specifically, the present invention is a method of teaching English and MIDI while providing professional training in various career fields in an effort to reduce terror attacks, increase public safety, and prevent the development of criminal behavior.

### BACKGROUND OF THE INVENTION

As of today, the United States has very little bargaining power with other countries, as far as trading is concerned. The less a country has to offer that appeals to the world market, the more at risk the citizens are at being abused financially, from the backlash of other countries charging ridiculously high fees for various goods and services. This is due to the nature of trading. Countries will make a large profit of off their products simply because other countries are not able to produce the same.

The Learn Naked Academy provides a solution to the current lack of United States presence in the trade market. By teaching Musical Instrument Digital Interface, otherwise known as MIDI, there can be a greater number of people who can create instruments using MIDI. Also, through learning MIDI, students can learn self-control and other behavioral skills that can be applied in other aspects of their lives.

Other countries are aware of the importance of understanding MIDI as they have experience in creating inexpensive devices that are usually sold to Americans at high costs. In other words, they are able to take advantage of the United States' lack of knowledge and development in the field of MIDI by creating products that the United States cannot develop and pricing them at high price points so they are able to make a substantial profit.

At this time however, other countries do not have a system in place that teaches small children loss prevention or MIDI, because if they had, that would be promoted as another certification to Americans for a fee. By the United States offering the service of training to children from any country, it allows them to be back in command with what will be considered to be fair prices for goods and services.

The Learn Naked Academy provides the means for the country to offer the first nationally and regionally recognized facility that is able to educate small children in the area of MIDI. This goal can be achieved, by granting the Learn Naked Academy the authority to be a Motivational Speaker Trade Association, whose authoritative power consists of granting degrees for Teachers of English to Speakers of Other Languages with a specialty in MIDI.

### BRIEF DESCRIPTION OF THE DRAWINGS

FIG. 1 shows a relationship diagram between the plurality of flashcards, English, MIDI, and professional training

FIG. 2 shows a relationship diagram between professional training and a profession.

FIG. 3 shows a relationship diagram of the results associated with teaching English.

FIG. 4 shows a relationship diagram of the results associated with learning and understanding English.

FIG. 5 shows a relationship diagram of the results associated with teaching MIDI.

FIG. 6 shows a relationship diagram of the results associated with learning and understanding MIDI.

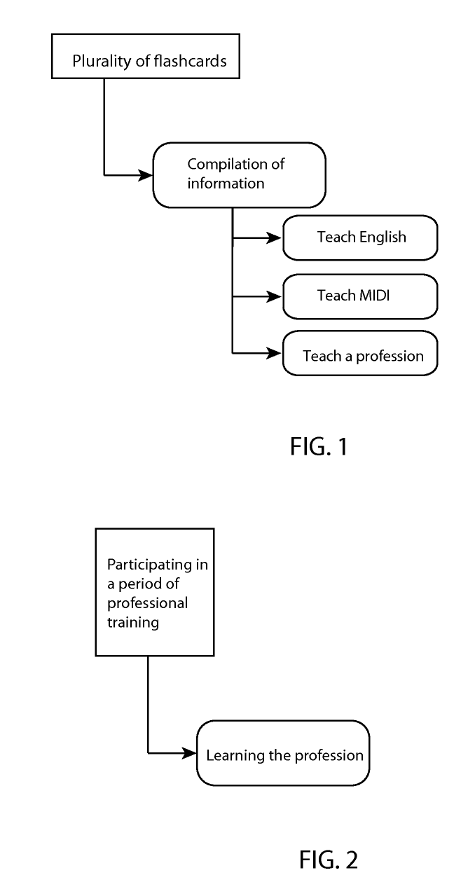

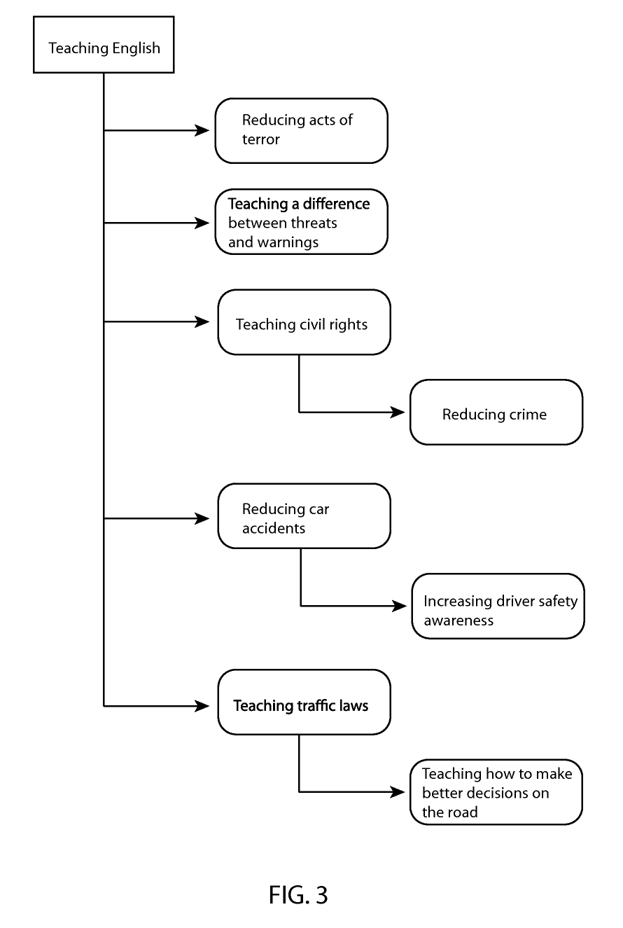

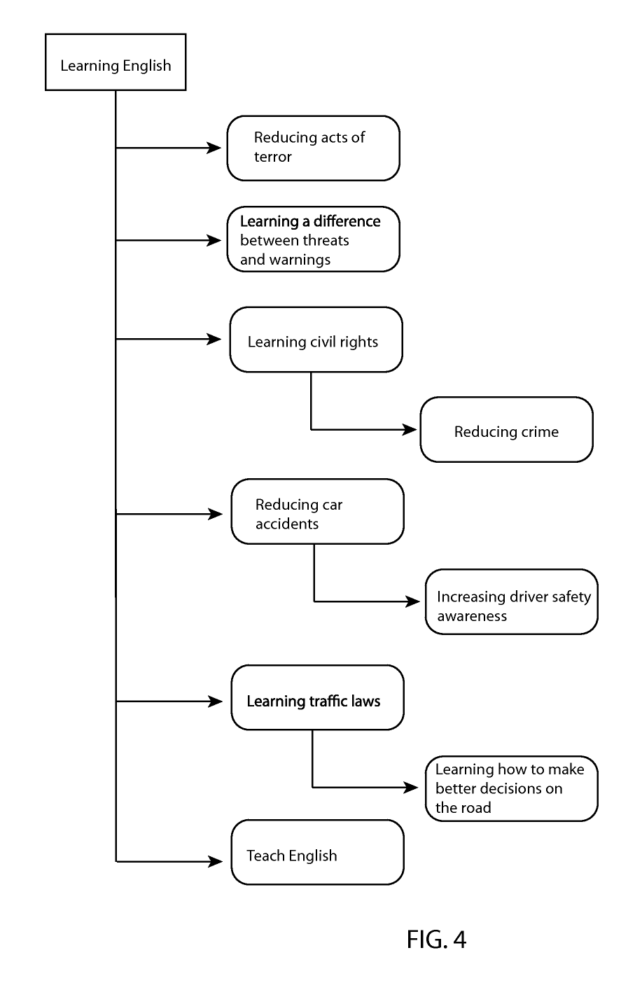

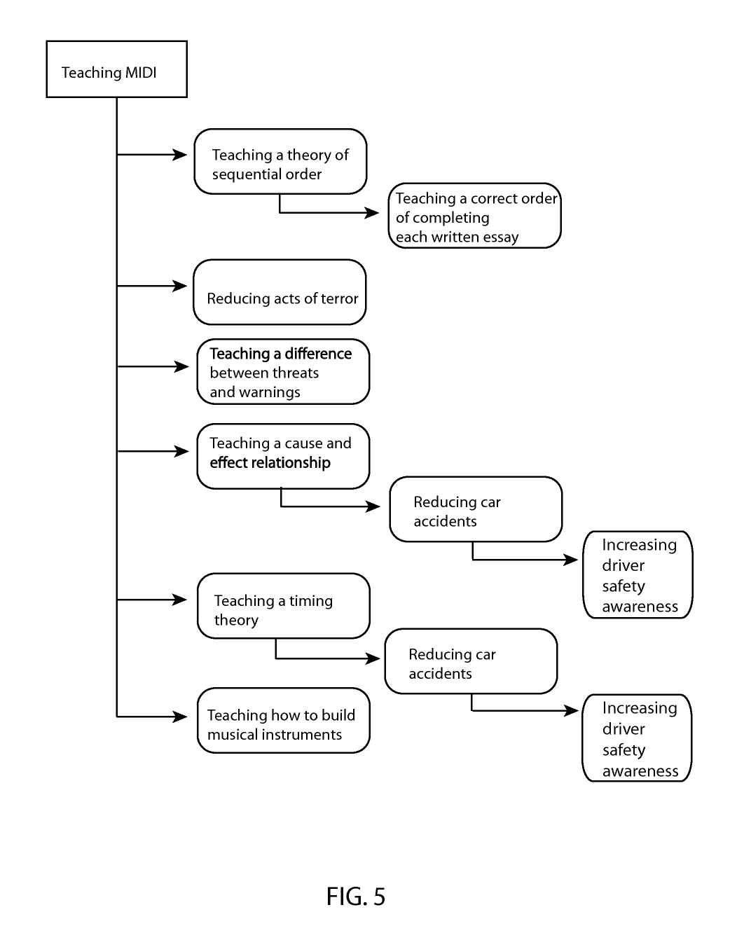

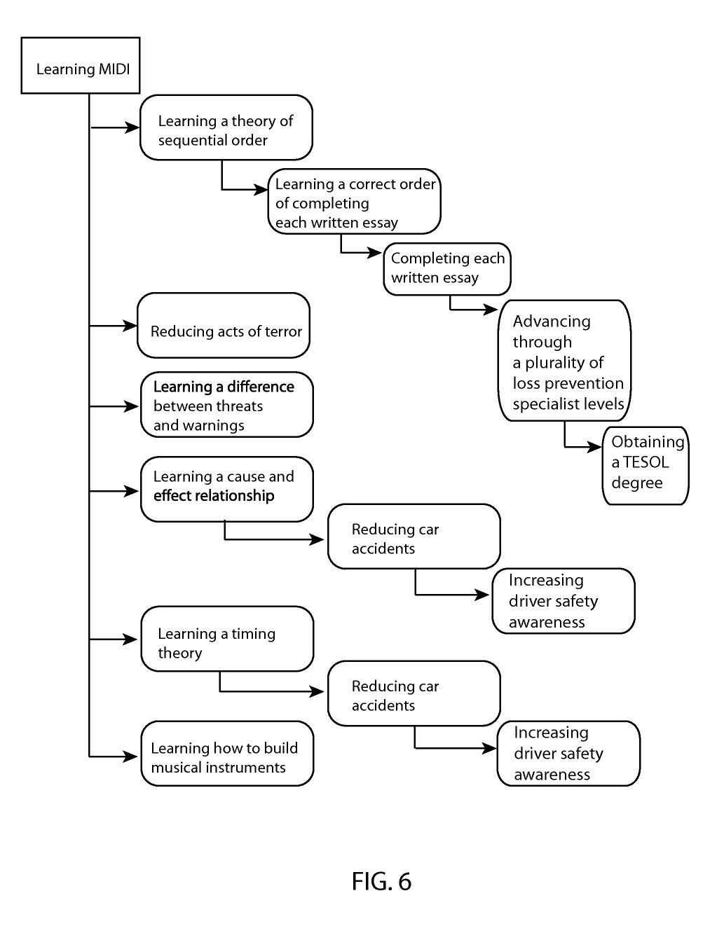

### DETAIL DESCRIPTIONS OF THE INVENTION

All illustrations of the drawings are for the purpose of describing selected versions of the present invention and are not intended to limit the scope of the present invention.

With the Learn Naked Academy, children can begin training in various professional fields earlier than the traditional years. This method of learning (and teaching) engages the student so they are able to stay interested in learning and excel further in their academic and professional careers. As a more lasting consequence, the United States can secure its position as a leader in education.

Obtaining a degree as a Teacher of English to Speakers of Other Languages (TESOL) is just the beginning for Learn Naked Academy trainees. Other aspects of the Learn Naked Academy include specializing in MIDI and receiving special training in a professional field. This alternative online educational system enables working certified professionals from all fields to add their knowledge to the academy as well as provide individual guidance to trainees by answering questions and leading discussions. Learn Naked Academy provides an environment which allows trainees to become experts in numerous fields.

Similar to one-on-one training, the Learn Naked Academy can help create strong professional relationships between a trainee and his mentor that can only benefit both later on. This type of training and relationship is often not provided in a traditional college experience. Trainees learn not only academic and professional wisdom from their mentors, but also a great deal of behavioral and professionals skills that can be applied to other area of life.

The Learn Naked Academy's alternative system of online learning and teaching is effective due to the fact that mentors train their trainees for fourteen years, which helps ensure that the needed material is understood. The present invention gives students who are at risk for failing or dropping out of high school the opportunity to work with professionals in their respective professional fields, without a formal degree. The mentors, are then able to evaluate the trainee's performance to see if they are well-qualified or not for the respective field. This is beneficial because it gives these students a second chance to prove themselves and achieve something greater. This system also helps to prevent students from failing classes if they are better equipped to verbally explain certain procedures as opposed to taking formal tests. This is an important feature because many students that may know the material but are not able to do well and pass a class because they cannot pass a written test. The Learn Naked Academy also helps with students who may not be able to learn effectively in a traditional classroom environment to get the benefits of a well-rounded education.

Graduates from Learn Naked Academy will be handpicked by their mentors who will train them on the job once each mentor believes his or her trainee is able to successfully perform certain tasks. The graduates will be able to legally practice in their chosen professions, hold the title of their chosen fields, without obtaining a traditional degree. This alternative method of learning eliminates the necessity of a traditional college degree only. In other words, the Learn Naked Academy is considered a professional school, allowing the trainees to skip college if they chose to do so. However, many participants will still be required to pass any needed test to be licensed by the perspective state board. For example, if a student's goal was to become a lawyer, he would still need to pass the Bar exam.

Over time, each mentor will submit keywords of their own profession by adding factual questions and answers to a defining words activity, creating unique set of flash cards. This will help to build a database of flashcards which will help strengthen the trainee's knowledge of not only different professions, but also MIDI and the English Language. Within the academy, trainees learn how to create their own study guides, specifically flash cards. Also, stories that are submitted for the loss prevention training, definitions of the core principles of MIDI as well as various mathematical equations will be studied in the form of flash cards. This process not only teaches trainees what the definitions of MIDI are, but it also helps them to understand how to derive an answer by learning about MIDI sequential order and detecting cause and effect relationships. Most children who fail tests and drop out of school do so because they have a difficult time understanding the course work. The learning process at the academy will help trainees understand the methodical process of how answers are found. By continuously learning in this manner, the method will become ingrained into the trainee so much so that he will be able to use this type of learning to help him comprehend other tasks. Also, flash cards can be arranged in a sequential order, which can help the trainee to remember information faster, thus further emphasizing the benefits of learning MIDI. Trainees learn how to define the meaning of words and phrases in their own words, which helps to stimulate their cognitive skills and as a result improve their ability to verbally communicate. By learning to effectively communicate verbally, trainees are able to learn how to properly channel their anger, how to identify, and self correct tantrums on school grounds.

Another objective of the Learn Naked Academy is to challenge each trainee to take excellent notes while in school as well as study on their own. Trainees will be challenged to communicate through writing only. Writing on a regular basis helps trainees to focus on important facts their teachers share with them in public schools. Therefore, all questions that trainees have for their mentors will be required to be detailed, well thought out questions in essay format.

Trainees will learn how to write essays in sequential order within the academy. Learning sequential order is vital to understanding how signals are transmitted and are able to communicate with each other. Trainees are taught step by step how to write essays from the rough draft, re-writing it, proofreading and also allowing someone else read and edit it. This method of writing essays mirrors the method of sequential order of MIDI. After one action, there is another that is dependent on the first. In terms of essays, proofreading is dependent on whether the trainee has completed his rough draft. Allowing someone else to edit it depends on if the trainee has completed proofreading it his or herself. Learning this process helps trainees understand that it is essential in nearly every job to justify their information correctly, take their time and also note any changes they make. This process is quite important in many job fields, including, but not limited to, communications. Proofreading on a regular basis can help trainees to become experts in the field they chose to practice. In this process, trainees learn to identify and self correct written documents. Also, continuously working on something (i.e. editing a written document) can help trainees control their need to get distracted on school grounds. This method of writing and editing follows a sequential order that mirrors that of MIDI because one can record their music and play it back to either “proofread” or edit, similar to how one would complete an essay. By writing and revising in this order, it is reinforcing what the trainees learned about MIDI. It also helps to show how following a sequential order can be beneficial towards an end goal.

Essays that contain content which glorify sexually explicit acts, pornography, rape, incest, drug use and/or alcohol abuse, violence, murder, and/or drive by shootings will be removed from the site and will not count for this training. However, essays that contain content expressing any of the pain, sadness, and negativity associated with underage sex, unprotected sex, rape, incest, drug use, alcohol abuse, violence, murder, and drive-by shootings are acceptable. Communicating through writing helps trainees deal with being bullied and teased as well as sharpens their communication and reading skills. This is because communicating through writing can be easier on some trainees as opposed to other tasks. It can be difficult to openly speak about feelings, especially to someone else, rather than writing the feelings down. It is another form of expressing one's anger or sadness, without the need act out.

The Learn Naked Academy has five different levels, differentiated by the amount of written essay submissions, to determine the level of degree that can be obtained. The first level has no equivalent traditional degree. It requires up to 100 written submissions and the trainee is labeled a loss prevention trainee. The next level is equivalent to an associate's degree, with a range of 101 to 250 essay submissions. At this level, the trainee is known as a loss prevention specialist. The third level, the senior loss prevention specialist, is equivalent to a bachelor's degree. Its number of essay submissions is from 251 to 350. The fourth level is the master trainer, which is equivalent to a master's degree. This level requires a submission of 351 to 500 essays. The final level is the senior master trainer with essay submissions ranging from 501 and above. This final level is equivalent to a doctrine degree. By allowing trainees to earn degrees based on the number of written essays they have submitted, the United States can become a leader in an alternative school system.

To help trainees grasp the concepts behind MIDI and understand how to use it, they will be exposed to terms and definitions that deal with audio engineering, which will help them to visualize how timing and MIDI are connected. Trainees will be encouraged to practice using devices at home that utilize MIDI interfaces. Most young people today are very skilled in creating musical instrumentals using audio software. Learning MIDI will enhance the trainee's knowledge of how the signals communicate back and forth that allow them to create their masterpieces. This is beneficial because it can lead to the creation of new market products that can help the United States in the trade platform.

Understanding MIDI helps to prepare trainees to take on the role of apprentice upon graduation. With the training they receive, trainees are able to work in any field with very little supervision. Employers who hire Learn Naked Academy's trainees will find highly intelligent individuals who are able to help keep the cost of repairs down. Graduating from Learn Naked Academy will help trainees become multi-talented, allowing them the opportunity to not only work in their chosen field, but also help out in the maintenance area when equipment breaks down and other fields as well.

Obtaining a degree from the Learn Naked Academy will teach trainees valuable skills that can be applied to fields outside of their concentrated career path. The Learn Naked Academy's curriculum provides the teaching of recognizing abuse and neglect, teaches MIDI itself, teaches methods of understanding actions and their respective consequences, which are all valuable in any professional field. The graduates come out as being well-rounded, versatile new professionals. Being taught loss prevention is essential to understanding not only MIDI, but also the English Language, as it helps trainees understand the difference between threats and abuse. After graduating from Learn Naked Academy, trainees can essentially do whatever they want to do, as the teachings and lessons learned from Learn Naked Academy can be applied to practically any field.

While MIDI itself follows a simple “note on” and “note off” concept, understanding how and why the notes can play and stop on command is essential. The “on” and “off” ability is created by pressing and releasing buttons, demonstrating the cause and effect relationship that is naturally embedded within MIDI. Pressing the button will turn the note “on” and releasing it will turn the note “off”. Understanding the causal relationship between the two actions will contribute to the trainee's ability to identify and comprehend actions and their consequences.

The other benefit in learning MIDI is that it can be used to create a variety of new instruments/electronic equipment that can boost America's standing in the world market. Through learning MIDI, trainees can learn about the benefits of sequential order. By understanding the correct order of events and how sequential order helped to create the right end result, the trainee will be able to see how beneficial following a sequential order is and how it can be applied to other aspects of life. Also, for those who are often at risk or troubled, it can show how positive, correct actions will lead to a positive end result, thus propelling them into a better future, provided that they choose to follow a sequential order path.

By combining driver safety training with loss prevention, the standards as far as what is considered abuse of not only driver's license, but also child abuse and neglect are raised. Trainees will hear random stories of abuse and threats, which will help them to understand better what reckless driving is. Trainees will be educated to be aware of commercial vehicles around them when they drive, which will help reduce roll over rates for trucks. Many accidents involving commercial vehicles are caused by class C drivers who were not paying attention to the road, leaving innocent victims to pay with their lives. As a result of the class C drivers not paying attention, not only do people get hurt and killed, but also, professional drivers lose their jobs and licenses, which can lead to many other problems. Learning to be more aware of their surroundings, will help trainees to understand that driving angry and making impulsive decisions based on emotion while driving is child abuse and neglect. Trainees will be educated to understand that any decision made that puts a child at risk for having to live without their parents due to parental negligence is child abuse. The theory behind MIDI is that there is a sequential order, control, and specific timing that dictate the signals that are used to communicate to each other to produce the end sound. By comprehending the idea of sequential order, they can apply this theory to driving by understanding that every action has a consequence.

Trainees will learn driver safety using all of the same methods explained for learning loss prevention and MIDI, except the flash cards used will have important facts concerning commercial trucks. Trainees will also be exposed to various mathematical equations, which will help them better understand that driving is all about counting which is related to timing. This concept of timing is very similar to MIDI. In MIDI, it is essential to time everything so every communication between the signals is correct. MIDI clocks are able to provide information to connected devices from the controlling device. The clocks keep all devices running at the same speed, which is crucial to ensuring the right notes are being played at the correct times. Another feature that also deals in relaying information in a timely manner in MIDI is the Song Position Pointer messages, otherwise known as SPP messages, which along with the MIDI clock, pass tempo and information regarding time signatures from one device to the other. Finally, there is a MIDI Time Code, or MTC, that syncs the time counters of devices connected to each other.

Trainees will also hear stories of abuse and threats, which will give them a real world example of how it would feel to be inside of a car with a driver who is out of control. This training will help trainees take driving seriously and prevent them from participating in activities such as talking on the phone while driving, reaching for items while driving.

The trainee can learn by the examples given through learning MIDI. While learning MIDI is a skill and the actual knowledge can be used for something productive such as creating new instrumental products, the ability to apply sequential order thinking and cause and effect thinking can help students in loss prevention. Having the trainees exposed to the relationship between an action and its consequences for one topic can lead to them understanding or at the very least detecting it in other topics.

Students can sometimes get bored in the traditional school setting from the usually mundane curriculum, which often leads to failing grades and high dropout rates; but hearing real life stories will motivate them to want to learn not only in the academy, but also in their public school. To ensure that trainees are given a clear understanding of what abuse is, there will be a mixture of stories; some will show abuse, and some will show threats. Through this technique, trainees will learn the difference of having control and not having control. They will essentially learn that things happen because of self-made decisions and that choices made in life have everything to do with timing. Learning this process will help each trainee understand what it takes to prevent the loss of their own life. With a deeper understanding of MIDI and mathematics, all things are possible including the prevention of highway accidents, environmental disasters as well as child abuse and neglect.

Licensed and certified individuals from all over the world are able to teach abuse through spoken word within the academy. In order to teach trainees real life situations, any person who has overcome the battle of struggles such as addiction or depression are also able to share their stories with students as well. In this case, motivational speakers are important to help influence trainees in the right way. By speaking openly about abuse and loss prevention, trainees can learn more about it and be able to recognize signs of abuse and loss prevention in real life situations. Also, hearing real stories, instead of hypothetical situations, about people abusing their clients' money or not paying attention to details and the consequences and issues that arise as a result can help to make the trainees more aware of loss prevention and dishonesty in business. Also, by hearing these real life stories, they can recognize and understand the sequential order that is true for all events, essentially they will be able to understand how a series of events can lead to abuse (physical, business, power, etc).

Preventing bullying and teasing on public school grounds is something that must be taught and enforced as early in life as possible. The trainees are taught using curriculum named Learn Naked™, which focuses on statistical literacy, MIDI sustain literacy as well as the curriculum, trainees learn the importance of controlling their actions civil rights literacy through treating every individual with respect. Trainees also learn that for every decision made, there are consequences, some are good and some are not. This educational system focuses on encouraging trainees to write, which will help children who harbor secrets of being bullied and teased to express themselves positively on paper. Trainees who participate will help to prevent the loss of not only their own life but the lives of others by removing fear, anger and guilt of their predator's actions from their conscience. MIDI exemplifies the idea that every action has a consequence because in MIDI, every signal communication produces a certain sound or has a certain effect. By continuously learning MIDI, a student can pick up on observing that relationship easily and as a result realize the negative consequences of bullying, which can help them to prevent bullying.

By allowing young children to be taught the core principles of civil rights alone, the justice system is able to utilize Learn Naked Academy as the missing link. Many children grow up and commit crimes without knowledge that what they are doing is considered a crime. Learn Naked Academy takes the guess work out of children's minds in the area of common sense. This method of learning would allow the United States to raise their standards and lengthen punishments for hate crimes committed.

With this invention, the United States of America opens the doors for small children to start their training for their careers ahead of all other countries, which increases its chances of regaining its position as the leader in all areas. This invention may even help to increase the chance that America will find the answers to overcome a multitude of issues ranging from global warming to exploring more of other galaxies.

Trainees of Learn Naked Academy are trained in the field of loss prevention and upon graduation, certified with a degree to teach English to Speakers of Other Languages, with a specialty in MIDI. Obtaining this certification helps to keep each new generation of trainees inspired to continue the tradition of mentoring a trainee.

The importance of learning MIDI stems from how common it is to find MIDI in everyday life. MIDI helps to control all devices in homes, offices and even cars. Learning MIDI helps trainees understand not only about sequential order but also helps them to understand how signals are used to communicate with each other in order for devices to work properly. Also, MIDI shows the relationship between two signals and how one can affect the other, thus teaching about how one action has many consequences and how the two are related.

Also, once a trainee has successfully graduated from Learn Naked Academy and been practicing with a license in their chosen field consecutively for a period of five years, they are eligible to chose their own apprentice. Trainees train on the job with their mentors until they successfully pass the licensing test from the board, however; mentors remain available to help guide each trainee for quick questions until their guidance is no longer needed. This practice helps create a never ending cycle of relevant job training, which is vital in order to make new discoveries in technology.

This program enables trainees to advance into multiple professional fields. Once a trainee masters one field, they are eligible for job training in another field, because the Learn Naked Academy eliminates the need for traditional degrees. Thus, a trainee can not only obtain multiple certificates, but also gain knowledge in various fields of study. This gives trainees who are highly gifted, who could otherwise use their intellect to successfully commit various crimes, an opportunity to utilize their gifts in various areas that can only benefit communities instead of creating harm. Also, with introduction of new professionals into the work field, there will be more intellect added to fields like cancer research and technology that can further progress society.

While Learn Naked Academy's main focus is on training troubled youth, and ensuring they have the opportunity to obtain a professional license, other applicants are welcomed into the program. Adults who have never obtained a professional license are also able to join the Learn Naked Academy. The program also allows adult mentors who contribute real life experience to obtain their professional license as well, by completing the same requirements of the younger trainees. This practices helps to educate younger individuals that achieving goals should never end. It also provides individuals who have real world experience and the required knowledge to pass the state board exams to advance in their careers; thereby increasing the chances of a new generation of professionals to arise in math and science fields.

Trainees are taught to be self motivated by reading out loud to them and encourage them to do the same. This practice prepares them to be motivational and educational speakers, as well as helps them to understand that doing the hardest things first helps to speed up completion daunting tasks. It also helps trainees self correct procrastination in completing their school work. This practices the teachings of MIDI because in MIDI, signals communicate back and forth to each other to produce an end result. Also, in MIDI, the recorded song or notes can be played out loud to understand exactly how it sounds. Listening to things out loud makes it easier to pick up mistakes and such that should not really be there, which may be not easy to figure out until it is heard out loud.

The Learn Naked Academy teaches trainees how to train their ear for music by posting various audio for them to audition. The audio used in this practice is from the defining words exercise, which is complied of random angry thoughts of abuse and threats written on paper. This practice strengthens their listening skills and helps them to self correct gossiping on school grounds.

Trainees can learn a lot at their mentor's place of work through various stories from individuals who either has been or presently in the working environment. This gives trainees a balanced view of how to be an honest business owner, as well as helps them to self correct lying to their parents and teachers.

Learn Naked Academy supports the No Child Left Behind Act. Therefore, it is mandatory that trainees complete high school in order for their degrees at the academy to remain active. Learn Naked Academy requires report cards from each trainee each year to verify their status at their respective high school. If any trainee drops out of school before he or she graduates high school, any degree achieved at the academy will become null and void. Learn Naked Academy will maintain a public listing of all valid degrees for the public to view at all times.

With trainees learning about MIDI and as a result sequential control, the importance of cause and effect relationships and timing, the trainees can learn more than technical knowledge. An objective of the Learn Naked Academy is for the teachings of MIDI and English to influence other aspects of the trainee's life. Learning MIDI can help create more self-control amongst other behavioral improvements that can help all situations the trainee may have to deal with. It is the desire of Learn Naked Academy to inspire trainees to respect their selves, their peers, and public school teachers. The academy instills in each trainee the importance of taking advantage of the opportunity to ask any question they have without worrying about being teased.

Although the invention has been explained in relation to its preferred embodiment, it is to be understood that many other possible modifications and variations can be made without departing from the spirit and scope of the invention as hereinafter claimed.

What is claimed is:

1. A method for loss prevention by means of studying MIDI with a plurality of techniques for giving degrees including a plurality of flashcards and a plurality of written essays,
Supplying a compilation of information by the plurality of flashcards;
Evaluating each written essay;
Teaching MIDI by the compilation of information on the plurality of flashcards;
Teaching English by the compilation of information on the plurality of flashcards;
Teaching a profession by the compilation of information on the plurality of flashcards;
Teaching a theory of sequential order by teaching MIDI;
Teaching a cause and effect relationship by teaching MIDI;
Teaching a timing theory by teaching MIDI; and
Teaching how to build musical instruments by teaching MIDI.

2. The method as claimed in claim 1 comprises,
Reducing acts of terror by teaching English and MIDI; and
Teaching a difference between threats and warnings through teaching English and MIDI.

3. The method as claimed in claim 1 comprises,
Teaching civil rights by teaching English; and
Reducing crime by teaching civil rights.

4. The method as claimed in claim 1 comprises,
Reducing car accidents by teaching English, the timing theory, and the cause and effect relationship;
Increasing driver safety awareness by reducing car accidents;
Teaching traffic laws through teaching English; and
Teaching how to make better decisions on the road by the users through teaching traffic laws.

5. The method as claimed in claim 1 comprises,
Teaching a correct order of completing each written essay by teaching the theory of sequential order.

6. A method for loss prevention by means of studying MIDI with a plurality of techniques for obtaining a degree or certification in loss prevention including a plurality of flashcards, a period of professional training, and a plurality of written essays,
Learning a compilation of information supplied by the plurality of flashcards;
Writing the plurality of written essays;
Participating in the period of professional training;
Learning MIDI by the compilation of information supplied by the plurality of flashcards;
Learning English by the compilation of information supplied by the plurality of flashcards;
Learning to teach English by learning English;
Learning a profession by the compilation of information supplied by the plurality of flashcards; and
Learning the profession by the participation in the period of professional training

7. The method as claimed in claim 6 comprises,
Learning a theory of sequential order by understanding MIDI;
Learning a cause and effect relationship by understanding MIDI;
Learning a timing theory by understanding MIDI; and
Learning how to build musical instruments by understanding MIDI.

8. The method as claimed in claim 6 comprises,
Reducing acts of terror by learning English and MIDI; and
Learning a difference between threats and warnings through learning English and MIDI.

9. The method as claimed in claim 6 comprises,
Learning civil rights by learning English; and
Reducing crime by learning civil rights.

10. The method as claimed in claim 7 comprises,
Reducing car accidents by teaching English, the timing theory, and the cause and effect relationship;
Increasing driver safety awareness by reducing car accidents;
Learning traffic laws through learning English; and
Learning how to make better decisions on the road by understanding traffic laws.

11. The method as claimed in claim 7 comprises,
Learning a correct order of completing each written essay by understanding the theory of sequential order;
Completing each written essay by following the correct order of completing each written essay;
Advancing through a plurality of loss prevention specialist levels by completing the plurality of written essays; and
Obtaining a TESOL degree by completing the plurality of loss prevention specialist levels.
